(19) United States
(12) Patent Application Publication
(10) Pub. No.: US 2017/0014922 A1
(43) Pub. Date: Jan. 19, 2017

(54) Power Skiving Assembly and Method of Operation of Same

(71) Applicant: Caterpillar Inc., Peoria, IL (US)

(72) Inventor: Gabriel Ellicott, Peoria Heights, IL (US)

(73) Assignee: Caterpillar Inc., Peoria, IL (US)

(21) Appl. No.: 14/799,619

(22) Filed: Jul. 15, 2015

(51) Int. Cl. B23F 21/06; B23F 21/10; B23C 5/20; B23F 5/16

(52) U.S. Cl. CPC B23F 21/066; B23F 5/163; B23F 21/106; B23C 5/207; B23C 2200/0433; B23C 2200/0477

(57) ABSTRACT

An insert, a housing, and a power skiving assembly each configured for use in a power skiving process is provided. The insert includes multiple cutting edges such that when one of the cutting edges is no longer suitable for use in a power skiving process, an orientation of the insert with respect to the housing can be changed so that another of the multiple cutting edges is aligned with a work piece upon which the power skiving process is being performed.

### TECHNICAL FIELD

This patent disclosure relates generally to gear cutting assemblies and, more particularly, to a power skiving assembly, and methods for operating the same.

### BACKGROUND

Power skiving is a process of cutting material in slices off of a work piece. Power skiving employs a combination of rotary and rectilinear relative motions between a milling tool and a work piece. One application for power skiving is the formation of gear teeth in a work piece to produce a gear.

Power skiving may have advantages over other machining processes. For example, power skiving typically requires less time to produce a finished gear. However, the tools used in power skiving, for example the portion of the tools that cut the teeth in the work piece, typically require a high degree accuracy in their tolerances. Use of the tools in power skiving processes can quickly dull or otherwise degrade the tools such that replacement of the tools is required frequently to maintain compliance with the required accuracy of the tolerances.

One example of a power skiving apparatus is described in U.S. Publication No. 2015/0063927 (SJOO). SJOO discloses a tool that includes a body that is configured to receive a plurality of inserts. Each of the inserts includes a single cutting edge. When the cutting edge of the insert is dulled or degraded to the point that the insert no longer complies with the required tolerances, the insert is removed from the body and replaced with a new insert. Replaceable cutting inserts manufactured by Pittler or VBMT include two diametrically opposed cutting edges, so that when the first cutting edge is no longer suitable for use, the insert can remounted such that the second cutting edge is positioned to engage the work piece.

While the use of a body and a plurality of inserts as disclosed in SJOO may avoid the need to replace an entire tool due to only a number of cutting edges becoming dull, and while an insert with two diametrically opposed cutting edges may prolong the life of an individual insert, the replacement of inserts can lead to significant costs during a power skiving process. These and other short comings of the prior art are addressed by the present disclosure.

### SUMMARY

According to an aspect of the disclosure, an insert is provided that is configured for use in a power skiving process. The insert includes a body including a first surface, a second surface opposite the first surface with respect to a first direction, an outer surface that extends from the first surface to the second surface, and an inner surface opposite the outer surface with respect to a second direction that is perpendicular to the first direction. The body further includes a first cutting edge, a second cutting edge opposite the first cutting edge with respect to the first direction, and an aperture defined by the inner surface such that the aperture extends from the first surface to the second surface.

According to another aspect of the disclosure, a housing is provided that is configured for use in a power skiving process. The housing comprises a body including a first surface, a second surface spaced from the first surface with respect to a first direction, an inner surface that extends along the first direction, an outer surface opposite the inner surface with respect to a second direction that is perpendicular to the first direction, an aperture defined by the inner surface such that the aperture extends from the first surface to the second surface along a central aperture axis that is parallel to the first direction, and a pocket that extends into the first surface along the first direction and terminates at a base surface of the body, the base surface including a first point and a second point that is spaced from the first point, the body further including a plane that is normal to the central aperture axis and intersecting the first surface. The first point is spaced from the central aperture axis by a first distance measured along a straight line that is perpendicular to the first direction, the first point is spaced from the plane by a first height measured along a straight line that is parallel to the first direction, the second point is spaced from the central aperture axis by a second distance measured along a straight line that is perpendicular to the first direction, the second point is spaced from the plane by a second height measured along a straight line that is parallel to the first direction, the second distance is greater than the first distance, and the second height is greater than the first height.

According to another aspect of the disclosure, a power skiving assembly is provided that comprises a housing body that includes a first surface, a second surface spaced from the first surface, a pocket that extends into the first and terminates at a base surface of the housing body, and a first aperture that extends into the base surface along a central first aperture axis, the central first aperture axis being parallel to a first direction. The power skiving assembly further comprises an insert body including a first surface, a second surface opposite the first surface of the insert body, a second aperture that extends through both the first surface of the insert body and the second surface of the insert body along a central second aperture axis, a first cutting edge defined by the first surface of the insert body, and a second cutting edge defined by the second surface of the insert body. The insert body is configured to be mounted to the housing body such that: 1) the first surface of the insert body faces the base surface, 2) the second surface of the insert body faces away from the base surface, and 3) the central second aperture axis is aligned with the central first aperture axis.

### BRIEF DESCRIPTION OF THE DRAWINGS

FIG. 1 is an isometric view of a work piece and a machine, according to an aspect of the disclosure, the machine including a power skiving assembly in a first configuration;

FIG. 2 is a top view of the work piece and power skiving assembly illustrated in FIG. 1;

FIG. 3 is an isometric view of the work piece and the machine illustrated in FIG. 1, the machine including the power skiving assembly in a second configuration;

FIG. 4 is an isometric view of a portion of the power skiving assembly illustrated in FIG. 1, the portion of the power skiving assembly including a tool;

FIG. 5 is a cross-sectional view of the tool illustrated in FIG. 4 along line 5-5, the tool including a housing and a plurality of inserts;

FIG. 6 is a cross-sectional view of a portion of the housing illustrated in FIG. 5;

FIG. 7 is a cross-sectional view of the tool of the power skiving assembly in accordance with an aspect of the disclosure, the tool including a housing and a plurality of inserts;

FIG. 8 is a cross-sectional view of a portion of the housing illustrated in FIG. 7;

FIG. 9 is a top view of one of the plurality of inserts illustrated in FIG. 4, according to an aspect of the disclosure;

FIG. 10 is a bottom view of the insert illustrated in FIG. 9;

FIG. 11 is a side view of the insert illustrated in FIG. 9;

FIG. 12 is another side view of the insert illustrated in FIG. 9;

FIG. 13 is an isometric view of the insert illustrated in FIG. 9;

FIG. 14 is another isometric view of the insert illustrated in FIG. 9;

FIG. 15 is a top view of one of the plurality of inserts illustrated in FIG. 4, according to an aspect of the disclosure;

FIG. 16 is a bottom view of the insert illustrated in FIG. 15;

FIG. 17 is a side view of the insert illustrated in FIG. 15;

FIG. 18 is another side view of the insert illustrated in FIG. 15;

FIG. 19 is an isometric view of the insert illustrated in FIG. 15;

FIG. 20 is another isometric view of the insert illustrated in FIG. 15;

FIG. 21 is a cross-sectional view of a portion of the tool illustrated in FIG. 4; and

FIG. 22 is a cross-sectional view of the portion of the tool illustrated in FIG. 21 during a power skiving process being performed on a work piece.

### DETAILED DESCRIPTION

Aspects of the disclosure will now be described in detail with reference to the drawings, wherein like reference numbers refer to like elements throughout, unless specified otherwise. Certain terminology is used in the following description for convenience only and is not limiting. The term “plurality”, as used herein, means more than one. The terms “a portion” and “at least a portion” of a structure include the entirety of the structure. Certain features of the disclosure which are described herein in the context of separate embodiments may also be provided in combination in a single embodiment. Conversely, various features of the disclosure that are described in the context of a single embodiment may also be provided separately or in any subcombination.

A radial or polar coordinate system is provided and described herein. The polar coordinate system includes a two dimensional radial plane that is centered on and normal to a reference axis, for instance a central axis of an aperture. The polar coordinate system defines a radial component that is measured as the distance from the reference axis along the plane. The words “proximate” and “distal” designate locations closer to and farther away from the reference axis, respectively, as measured along the plane. The polar coordinate system further defines an angular component that is measured as the angular position about the reference axis.

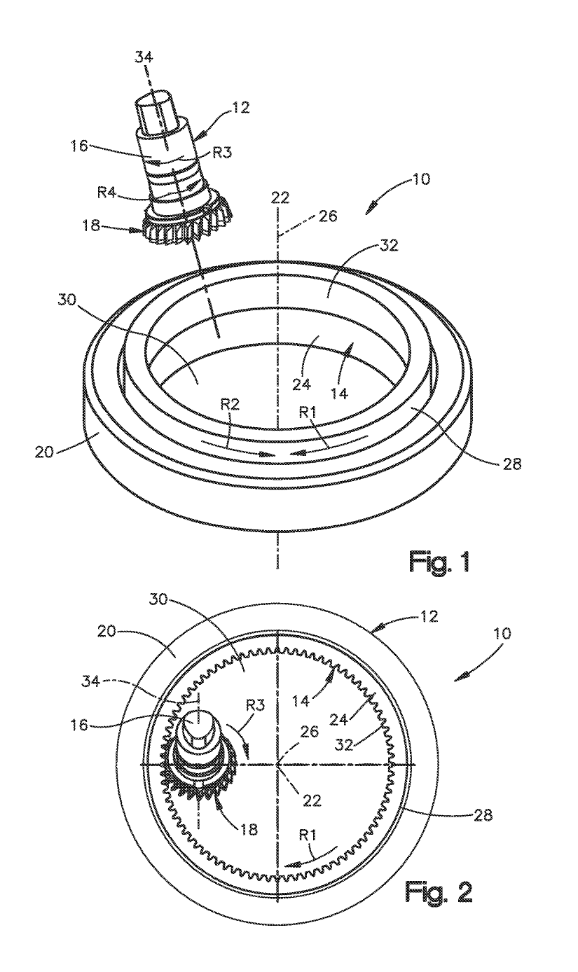

Referring to FIGS. 1 to 4, a machine 10, for example a power skiving assembly 12, is disclosed that is configured for use in a power skiving process. The power skiving process may include, for example, forming gear teeth in a work piece 14. The power skiving assembly 12 may include a movable arm 16, a tool 18 configured to be coupled to the movable arm 16, a clamp 20 configured to be coupled to the work piece 14, or any combination thereof

According to one aspect of the disclosure, the work piece 14 is coupled to the clamp 20 such that the work piece 14 is restricted, for example prevented, from moving relative to the clamp 20 in at least one degree of freedom. According to one aspect of the disclosure, the work piece 14 is coupled to the clamp 20 such that the work piece 14 is prevented from moving relative to the clamp 20 in all six degrees of freedom. According to one embodiment, the work piece 14 is rotatably coupled to the clamp 20 such that the work piece 14 and the clamp 20 are rotatable together about a first assembly axis of rotation 22. The coupled work piece 14 and clamp 20 may be rotatable about the first assembly axis of rotation 22 in a first rotational direction R1, for example clockwise with respect to a reference point, a second rotational direction R2 that is opposite the first rotational direction R1, for example counter-clockwise with respect to the reference point, or both the first rotational direction R1 and the second rotational direction R2.

The work piece 14 includes a work piece body 24, for example a tubular body or a ring-shaped body, that defines a work piece axis 26 which extends through the work piece body 24. According to one aspect of the disclosure, the work piece 14 includes a work piece body 24 that is a tubular body with a circular shape defined by an outer surface 28 of the work piece body 24, the work piece body 24 includes a through hole 30 defined by an inner surface 32 of the work piece body 24, and the work piece 14 includes a work piece axis 26 that extends centrally through the through hole 30. As shown in the illustrated embodiment, the work piece 14 may be coupled to the clamp 20 such that the first assembly axis of rotation 22 and the work piece axis 26 are collinear.

According to one aspect of the disclosure, the power skiving assembly 12 is configured such that the movable arm 16 is rotatable about a second assembly axis of rotation 34, translatable relative to the clamp 20 (and the work piece 14 when coupled to the clamp 20) along a first direction parallel to the first assembly axis of rotation 22, translatable along a second direction parallel to a plane that is normal to the first assembly axis of rotation 22, or any combination thereof. The movable arm 16 may be rotatable about the second assembly axis of rotation 34 in a third rotational direction R3, for example clockwise with respect to a reference point, a fourth rotational direction R4 that is opposite the third rotational direction R3, for example counter-clockwise with respect to the reference point, or both the third rotational direction R3 and the fourth rotational direction R4. The power skiving assembly 12 may be configured such that the first assembly axis of rotation 22 is offset from the second assembly axis of rotation 34 by an angle α. Alternatively, the power skiving assembly 12 may be configured such that the first assembly axis of rotation 22 is parallel to the second assembly axis of rotation 34.

The tool 18, according to one aspect of the disclosure, the tool 18 is configured to be coupled to the movable arm 16, for example by a fastener 36, such that the tool 18 is restricted, for example prevented, from moving relative to the movable arm 16 in at least one degree of freedom. According to one aspect of the disclosure, the tool 18 is configured to be coupled to the movable arm 16 such that the tool 18 is prevented from moving relative to the movable arm 16 in all six degrees of freedom. According to one embodiment, the tool 18 is rotatably coupled to the movable arm 16 such that the tool 18 and the movable arm 16 are rotatable together about the second assembly axis of rotation 34 in the third rotational direction R3, the fourth rotational direction R4, or both. As shown in the illustrated embodiment, the movable arm 16 and the coupled tool 18 are rotatable about the second assembly axis of rotation 34 in the third rotational direction R3 and the clamp 20 and the coupled work piece 14 are rotatable about the first assembly axis of rotation 22 in the first rotational direction R1.

Referring to FIG. 5, according to one aspect of the disclosure, the tool 18 includes a housing 40 and a plurality of inserts 80 that are configured to be coupled to the housing 40. The plurality of inserts 80 are coupled to the housing 40 such that during a power skiving process the plurality of inserts 80 are configured to contact the work piece 14, for example the inner surface 32 of the work piece 14 (shown in FIG. 1), and to remove, for example slice off, material from the work piece 14.

The housing 40 may include a housing body 42 and a housing aperture 44 that extends through the housing body 42. As shown in the illustrated embodiment, the housing aperture 44 may extend into a first surface 46 of the housing body 42, along a housing aperture axis 48, toward a second surface 50 spaced from the first surface 46 with respect to a third direction that is parallel to the housing aperture axis 48. The second surface 50 may be opposite the first surface 46 with respect to the third direction. As shown in the illustrated embodiment, the housing aperture 44 may include a through hole that extends from the first surface 46 to the second surface 50 such that the housing aperture 44 defines a passage through an entirety of the housing body 42 with respect to the third direction. Alternatively, the housing aperture 44 may terminate at a surface between the first surface 46 and the second surface 50 with respect to the third direction.

The first surface 46, the second surface 50, or both may be substantially planar, for example such that the respective surface lies substantially within a plane that is normal to the housing aperture axis 48. The housing 40 may include an outer perimeter 52 defined by an outer surface 54 of the housing body 42. The housing 40 may further include an inner surface 56 opposite the outer surface 54 along a radial ray 58 that extends from the housing aperture axis 48, through the inner surface 56, and through the outer surface 54. As shown in the illustrated embodiment, the inner surface 56 may define the housing aperture 44.

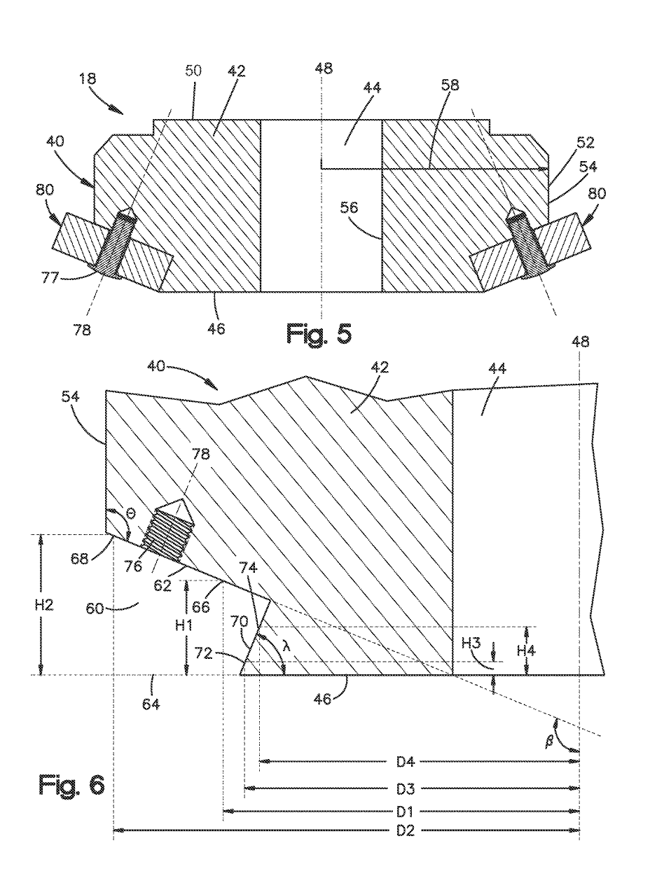

Referring to FIG. 6, the housing 40 includes a pocket 60. According to one aspect of the disclosure, the pocket 60 is one of a plurality of pockets 60. Each of the plurality of pockets 60 may be substantially identical such that the description of the pocket 60 below is applicable to each of the plurality of pockets 60. Alternatively, some of the plurality of pockets 60 may have different dimensions than others of the plurality of pockets 60.

The pocket 60 extends into the first surface 46 of the housing body 42 along the third direction, and terminates at a base surface 62 of the housing body 42. The pocket 60 defines a distance, for example a height, that is measured from a plane 64 that is normal to the housing aperture axis 48 and that intersects the first surface 46 to the base surface 62 along a straight line that is parallel to the housing aperture axis 48. The plane 64, as viewed in FIG. 6, extends into and out of the page and is therefore illustrated as a line. As shown in the illustrated embodiment, the height of the pocket 60 may be different at various locations along the base surface 62.

According to one aspect of the disclosure, the base surface 62 includes a plurality of points, including at least a first point 66 and a second point 68 spaced from the first point 66. For example, the first point 66 is spaced from the housing aperture axis 48 by a first distance D1 that is measured along a straight line that is perpendicular to the housing aperture axis 48, and the first point 66 is spaced from the plane 64 by a first height H1 that is measured along a straight line that is parallel to the housing aperture axis 48. The second point 68 is spaced from the housing aperture axis 48 by a second distance D2 that is measured along a straight line that is perpendicular to the housing aperture axis 48, and the second point 68 is spaced from the plane 64 by a second height H2 that is measured along a straight line that is parallel to the housing aperture axis 48. The housing body 42 may be configured such that the second distance D2 is greater than the first distance D1, and the second height H2 is greater than the first height H1.

The pocket 60 may further extend into the outer surface 54 along a fourth direction perpendicular to the housing aperture axis 48. A portion of the pocket 60 may terminate at an intermediate side surface 70 of the housing body 42. According to one aspect of the disclosure, the intermediate side surface 70 is perpendicular to the base surface 62. The intermediate side surface 70 includes a plurality of points, including at least a third point 72 and a fourth point 74 spaced from the third point 72. For example, the third point 72 is spaced from the housing aperture axis 48 by a third distance D3 that is measured along a straight line that is perpendicular to the housing aperture axis 48, and the third point 72 is spaced from the plane 64 by a third height H3 that is measured along a straight line that is parallel to the housing aperture axis 48. The fourth point 74 is spaced from the housing aperture axis 48 by a fourth distance D4 that is measured along a straight line that is perpendicular to the housing aperture axis 48, and the fourth point 74 is spaced from the plane 64 by a fourth height H4 that is measured along a straight line that is parallel to the housing aperture axis 48. The housing body 42 may be configured such that the third distance D3 is greater than the fourth distance D4, and the fourth height H4 is greater than the third height H3.

According to one aspect of the disclosure, the housing body 42 may be configured such that an angle β is defined between the base surface 62 and the housing aperture axis 48, the angle β being greater than 90° and less than 180°. According to one embodiment the angle β is between about 100° and about 135°. According to one aspect of the disclosure, the housing body 42 may be configured such that an angle θ is defined between the outer surface 54 and the base surface 62, the angle θ being greater than 90° and less than 180°. According to one embodiment the angle θ is between about 100° and about 135°. According to one aspect of the disclosure, the housing body 42 may be configured such that an angle λ is defined between the intermediate side surface 70 and the first surface 46, the angle λ being greater than 0° and less than 90°. According to one embodiment the angle λ is between about 25° and about 75°.

Referring to FIGS. 5 and 6, the housing 40, according to one aspect of the disclosure, may include a fastener aperture 76 configured to receive a fastener 77, for example a screw, to couple one of the plurality of inserts 80 to the housing 40, for example in the pocket 60. The fastener aperture 76 may extend into the base surface 62 along a central fastener aperture axis 78. The central fastener aperture axis 78 may extend into the base surface 62 along a direction, for example a direction nonparallel with respect to the housing aperture axis 48.

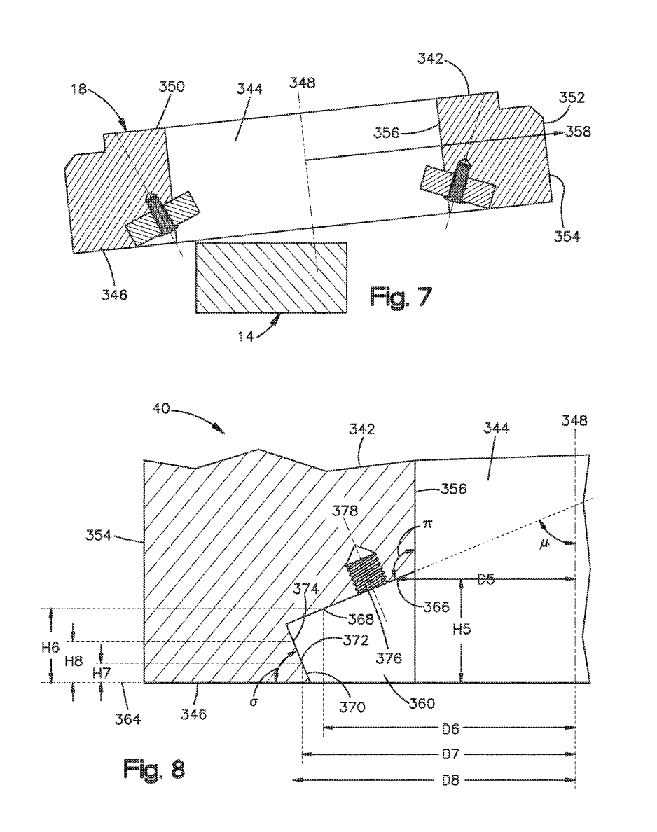

Referring to FIG. 7, according to one aspect of the disclosure, the tool 18 includes a housing 40 and a plurality of inserts 80 that are configured to be coupled to the housing 40. The plurality of inserts 80 are coupled to the housing 40 such that during a power skiving process the plurality of inserts 80 are configured to contact the work piece 14, for example the outer surface 33 of the work piece 14, and remove, for example slice off, material from the work piece 14.

The housing 40 may include a housing body 342 and a housing aperture 344 that extends into a first surface 346 of the housing body 342 along a housing aperture axis 348 toward a second surface 350 spaced from, for example opposite, the first surface 346 with respect to a direction parallel to the housing aperture axis 348. As shown in the illustrated embodiment, the housing aperture 344 may include a through hole that extends from the first surface 346 to the second surface 350 such that the housing aperture 344 defines a passage through an entirety of the housing body 342 with respect to the direction parallel to the housing aperture axis 348. As shown, the housing aperture 344 may be configured to receive and allow passage of the work piece 14 through the housing aperture 344 during a power skiving process.

The first surface 346, the second surface 350, or both may be substantially planar, for example such that the respective surface lies substantially within a plane that is normal to the housing aperture axis 348. The housing 40 may include an outer perimeter 352 defined by an outer surface 354 of the housing body 342, and an inner surface 356 opposite the outer surface 354 along a radial ray 358 that extends from the housing aperture axis 348, through the inner surface 356, and through the outer surface 354. As shown in the illustrated embodiment, the inner surface 356 may at least partially define the housing aperture 344.

Referring to FIG. 8, the housing 40 includes a pocket 360. According to one aspect of the disclosure, the pocket 360 is one of a plurality of pockets 360. Each of the plurality of pockets 360 may be substantially identical such that the description of the pocket 360 below is applicable to each of the plurality of pockets 360. Alternatively, some of the plurality of pockets 360 may have different dimensions than others of the plurality of pockets 360.

The pocket 360 extends into the first surface 346 of the housing body 342 along the direction parallel to the housing aperture axis 348, and terminates at a base surface 362 of the housing body 342. The pocket 360 defines a distance, for example a height, that is measured from a plane 364 that is normal to the housing aperture axis 348 and that intersects the first surface 346 to the base surface 362 along a straight line that is parallel to the housing aperture axis 348. As shown in the illustrated embodiment, the height of the pocket 360 may be different at various locations along the base surface 362.

According to one aspect of the disclosure, the base surface 362 includes a plurality of points, including at least a first point 366 and a second point 368 spaced from the first point 366. For example, the first point 366 is spaced from the housing aperture axis 348 by a fifth distance D5 that is measured along a straight line that is perpendicular to the housing aperture axis 348, and the first point 366 is spaced from the plane 364 by a fifth height H5 that is measured along a straight line that is parallel to the housing aperture axis 348. The second point 368 is spaced from the housing aperture axis 348 by a sixth distance D6 that is measured along a straight line that is perpendicular to the housing aperture axis 348, and the second point 368 is spaced from the plane 364 by a sixth height H6 that is measured along a straight line that is parallel to the housing aperture axis 348. The housing body 342 may be configured such that the sixth distance D6 is greater than the fifth distance D5, and the fifth height H5 is greater than the sixth height H6.

The pocket 360 may further extend into the inner surface 356 along a direction perpendicular to the housing aperture axis 348. A portion of the pocket 360 may terminate at an intermediate side surface 370 of the housing body 342. According to one aspect of the disclosure, the intermediate side surface 370 is perpendicular to the base surface 362. The intermediate side surface 370 includes a plurality of points, including at least a third point 372 and a fourth point 374 spaced from the third point 372. For example, the third point 372 is spaced from the housing aperture axis 348 by a seventh distance D7 that is measured along a straight line that is perpendicular to the housing aperture axis 348, and the third point 372 is spaced from the plane 364 by a seventh height H7 that is measured along a straight line that is parallel to the housing aperture axis 348. The fourth point 374 is spaced from the housing aperture axis 348 by an eighth distance D8 that is measured along a straight line that is perpendicular to the housing aperture axis 348, and the fourth point 374 is spaced from the plane 364 by an eighth height H8 that is measured along a straight line that is parallel to the housing aperture axis 348. The housing body 342 may be configured such that the eighth distance D8 is greater than the seventh distance D7, and the eighth height H8 is greater than the seventh height H7.

According to one aspect of the disclosure, the housing body 342 may be configured such that an angle μ is defined between the base surface 362 and the housing aperture axis 348, the angle μ being greater than 90° and less than 180°. According to one embodiment the angle μ is between about 100° and about 135°. According to one aspect of the disclosure, the housing body 342 may be configured such that an angle π is defined between the inner surface 356 and the base surface 362, the angle π being greater than 90° and less than 180°. According to one embodiment the angle π is between about 100° and about 135°. According to one aspect of the disclosure, the housing body 342 may be configured such that an angle σ is defined between the intermediate side surface 370 and the first surface 346, the angle σ being greater than 0° and less than 90°. According to one embodiment the angle σ is between about 25° and about 75°.

Referring to FIGS. 7 and 8, the housing 40, according to one aspect of the disclosure, may include a fastener aperture 376 configured to receive a fastener, for example a screw, to couple one of the plurality of inserts 80 to the housing 40, for example in the pocket 360. The fastener aperture 376 may extend into the base surface 362 along a central fastener aperture axis 378. The central fastener aperture axis 378 may extend into the base surface 362 along a direction, for example a direction nonparallel with respect to the housing aperture axis 348.

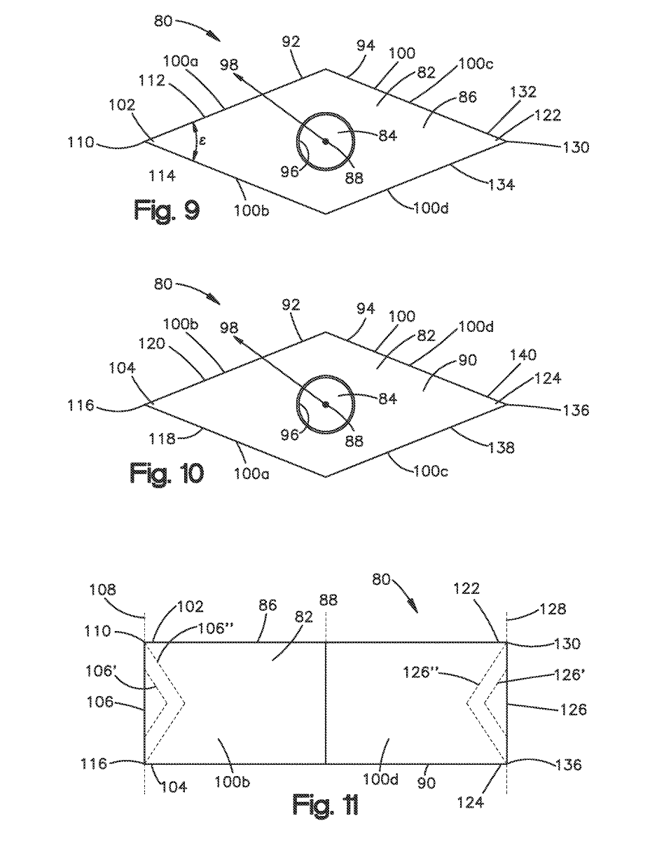

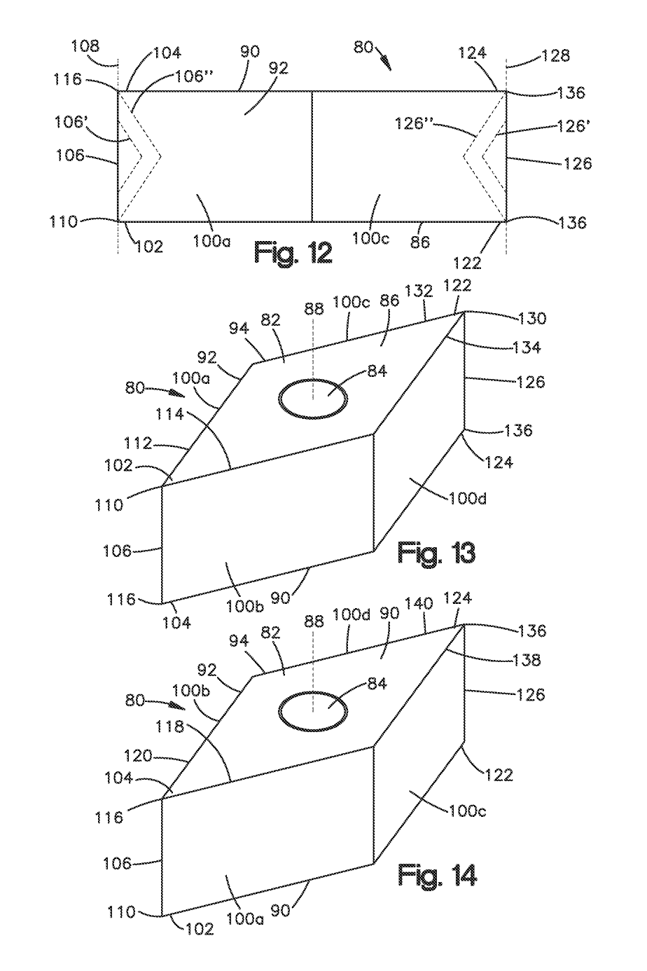

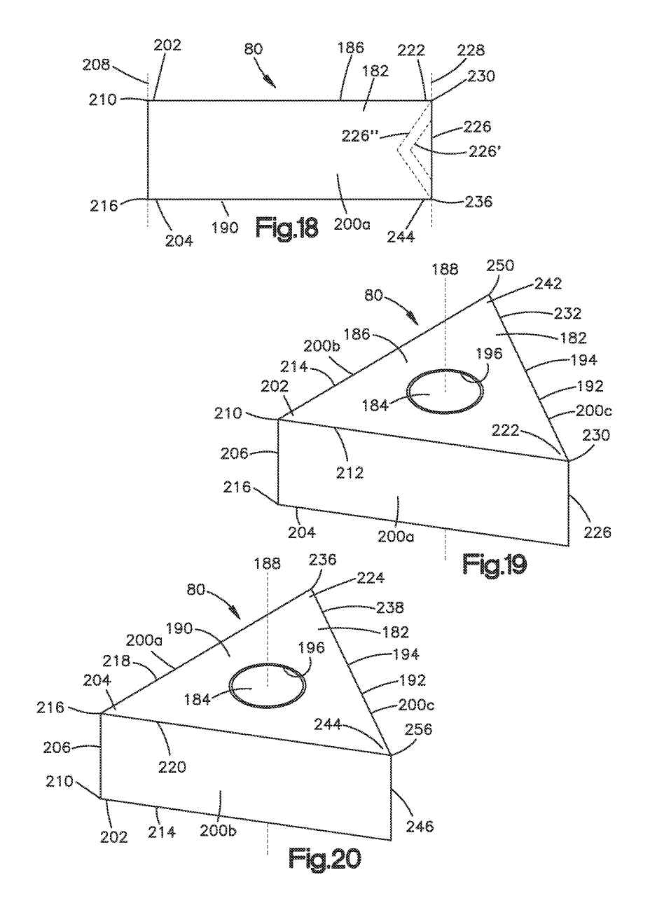

Referring to FIGS. 9-20, according to one aspect of the disclosure each of the plurality of inserts 80 may be substantially identical such that the description of the insert 80 below is applicable to each of the plurality of inserts 80. Alternatively, some of the plurality of inserts 80 may have different dimensions than others of the plurality of inserts 80.

Referring to FIGS. 9-14, the insert 80 includes an insert body 82 and an insert aperture 84 that extends into a first surface 86 of the insert body 82 along an insert aperture axis 88, for example a central aperture axis, toward a second surface 90 spaced from, for example opposite, the first surface 86 with respect to a fifth direction, for example a direction parallel to the insert aperture axis 88. As shown in the illustrated embodiment, the insert aperture 84 may include a through hole that extends from the first surface 86 to the second surface 90 such that the insert aperture 84 defines a passage through an entirety of the insert body 82 with respect to the fifth direction. Alternatively, the insert aperture 84 may terminate at a surface between the first surface 86 and the second surface 90 with respect to the fifth direction.

The first surface 86, the second surface 90, or both may be substantially planar, for example such that the respective surface lies substantially within a plane that is normal to the insert aperture axis 88. The insert body 82 may include an outer perimeter 92 defined by an outer surface 94 of the insert body 82, and the insert body 82 may further include an inner surface 96 opposite the outer surface 94 along a radial ray 98 that extends from the insert aperture axis 88 in a sixth direction, for example a direction perpendicular to the insert aperture axis 88, through the inner surface 96, and then through the outer surface 94. As shown, the inner surface 96 may define the insert aperture 84.

The outer surface 94 may include a plurality of side walls 100. According to one aspect of the disclosure, the outer surface 94 includes four side walls 100 arranged such that the outer perimeter 92 of the insert body 82 is a parallelogram shape.

The insert body 82 includes a plurality of cutting edges that are each configured to remove material from a work piece during a power skiving process as will be described in greater detail below. According to one aspect of the disclosure, the plurality of cutting edges includes a first cutting edge 102 and a second cutting edge 104 opposite the first cutting edge 102 with respect to the fifth direction. In accordance with one aspect of the disclosure, the insert body 82 further includes a flank face 106 at least partially, for example entirely, defined by an intersection of a first of the plurality of side walls 100a and a second of the plurality of side walls 100b.

According to one aspect of the disclosure, at least a portion of the flank face 106 extends along a straight line 108 that intersects both the first surface 86 and the second surface 90, and is parallel to the insert aperture axis 88. An entirety of the flank face 106 may be collinear with the straight line 108. An entirety of the flank face 106 may extend along the straight line 108 such that an entirety of the flank face 106 is perpendicular to the both the first surface 86 and the second surface 90. Alternatively, the flank face 106 may include a portion that is tapered toward the insert aperture axis 88, for example as represented by either of the dashed lines 106′ and 106″.

The insert body 82 may be configured such that the insert body 82 is devoid of a portion, for example a portion of the flank face 106, that crosses the straight line 108. The insert body 82 may be configured such that a radial ray 109 extends radially from the insert aperture axis 88 and intersects the straight line 108 at a first position, and the insert body 82 is devoid of a portion, for example a portion of the flank face 106, that intersects the radial ray 109 at a second position that is farther, radially, from the insert aperture axis 88 than the first position is, radially, from the insert aperture axis 88.

The insert body 82 may include a first nose edge 110 defined by an intersection of the flank face 106 and the first surface 86, a first flank edge 112 defined by an intersection of the first of the plurality of side walls 100a and the first surface 86, a second flank edge 114 defined by an intersection of the second of the plurality of side walls 100b and the first surface 86, a second nose edge 116 defined by an intersection of the flank face 106 and the second surface 90, a third flank edge 118 defined by an intersection of the first of the plurality of side walls 100a and the second surface 90, a fourth flank edge 120 defined by an intersection of the second of the plurality of side walls 100b and the second surface 90, or any combination thereof

According to one aspect of the disclosure, the first cutting edge 102 is defined by the first nose edge 110, a portion of the first flank edge 112, a portion of the second flank edge 114, or any combination thereof. The second cutting edge 104 may be defined by the second nose edge 116, a portion of the third flank edge 118, a portion of the fourth flank edge 120, or any combination thereof. For example the first cutting edge 102 may be defined by the first nose edge 110, a portion of the first flank edge 112 proximate the first nose edge 110, and a portion of the second flank edge 114 proximate the first nose edge 110, and the second cutting edge 104 may be defined by the second nose edge 116, a portion of the third flank edge 118 proximate the second nose edge 116, and a portion of the fourth flank edge 120 proximate the second nose edge 116.

The plurality of cutting edges may further include a third cutting edge 122 and a fourth cutting edge 124 opposite the third cutting edge 122 with respect to the fifth direction. The flank face 106 may be a first flank face 106 and the insert body 82 may include a second flank face 126 at least partially, for example entirely, defined by an intersection of a third of the plurality of side walls 100c and a fourth of the plurality of side walls 100d. The first cutting edge 102 may be diametrically opposite to the third cutting edge 122 with respect to the insert aperture axis 88, and the second cutting edge 104 may be diametrically opposite to the fourth cutting edge 124 with respect to the insert aperture axis 88.

According to one aspect of the disclosure, at least a portion of the second flank face 126 extends along a second straight line 128 that intersects both the first surface 86 and the second surface 90, and is parallel to the insert aperture axis 88. As shown, the second straight line 128 may be diametrically opposite the straight line 108 with respect to the insert aperture axis 88. An entirety of the second flank face 126 may be collinear with the second straight line 128. An entirety of the second flank face 126 may extend along the second straight line 128 such that an entirety of the second flank face 126 is perpendicular to the both the first surface 86 and the second surface 90. Alternatively, the second flank face 126 may include a portion that is tapered toward the insert aperture axis 88, for example as represented by either of the dashed lines 126′ and 126″. The insert body 82 may be configured such that the insert body 82 is devoid of a portion, for example a portion of the second flank face 126, that crosses the second straight line 128.

The insert body 82 may include a third nose edge 130 defined by an intersection of the second flank face 126 and the first surface 86, a fifth flank edge 132 defined by an intersection of the third of the plurality of side walls 100c and the first surface 86, a sixth flank edge 134 defined by an intersection of the fourth of the plurality of side walls 100d and the first surface 86, or any combination thereof. The insert body 82 may further include a fourth nose edge 136 defined by an intersection of the second flank face 126 and the second surface 90, a seventh flank edge 138 defined by an intersection of the third of the plurality of side walls 100c and the second surface 90, an eighth flank edge 140 defined by an intersection of the fourth of the plurality of side walls 100d and the second surface 90, or any combination thereof

According to one aspect of the disclosure, the third cutting edge 122 is defined by the third nose edge 130, a portion of the fifth flank edge 132, a portion of the sixth flank edge 134, or any combination thereof. The fourth cutting edge 124 may be defined by the fourth nose edge 136, a portion of the seventh flank edge 138, a portion of the eighth flank edge 140, or any combination thereof. For example the third cutting edge 122 may be defined by the third nose edge 130, a portion of the fifth flank edge 132 proximate the third nose edge 130, and a portion of the sixth flank edge 134 proximate the third nose edge 130, and the forth cutting edge 124 may be defined by the fourth nose edge 136, a portion of the seventh flank edge 138 proximate the fourth nose edge 136, and a portion of the eighth flank edge 140 proximate the fourth nose edge 136.

The first cutting edge 102, the second cutting edge 104, the third cutting edge 122, the fourth cutting edge 124, or any combination thereof may define an angle ε measured between the respective flank edges that define the respective cutting edge. For example, the first cutting edge 102 may define the angle ε between the first flank edge 112 and the second flank edge 114, the second cutting edge 104 may define the angle ε between the third flank edge 118 and the fourth flank edge 120, etc. According to one aspect of the disclosure the angle ε is less than 90°. According to one aspect of the disclosure the angle ε is about 45°. According to one aspect of the disclosure the angle ε is less than 45°. According to one aspect of the disclosure the angle ε of defined by each of the first cutting edge 102, the second cutting edge 104, the third cutting edge 122, and the fourth cutting edge 124 is equal. Alternatively, the angle ε of defined by at least two of the first cutting edge 102, the second cutting edge 104, the third cutting edge 122, and the fourth cutting edge 124 is different.

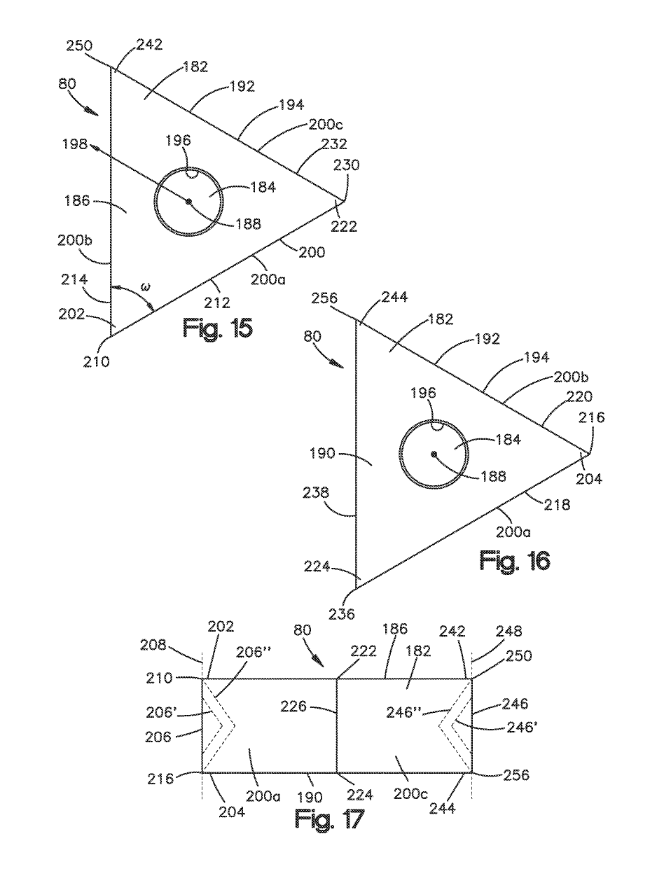

Referring to FIGS. 15-20, the insert 80 includes an insert body 182 and an insert aperture 184 that extends into a first surface 186 of the insert body 182 along an insert aperture axis 188 toward a second surface 190 spaced from, for example opposite, the first surface 186 with respect to a seventh direction, for example a direction parallel to the insert aperture axis 188. As shown in the illustrated embodiment, the insert aperture 184 may include a through hole that extends from the first surface 186 to the second surface 190 such that the insert aperture 184 defines a passage through an entirety of the insert body 182 with respect to the seventh direction. Alternatively, the insert aperture 184 may terminate at a surface between the first surface 186 and the second surface 190 with respect to the seventh direction.

The first surface 186, the second surface 190, or both may be substantially planar, for example such that the respective surface lies substantially within a plane that is normal to the insert aperture axis 188. The insert body 182 may include an outer perimeter 192 defined by an outer surface 194 of the insert body 182, and the insert body 182 may further include an inner surface 196 opposite the outer surface 194 along a radial ray 198 that extends from the insert aperture axis 188 in an eighth direction, for example a direction perpendicular to the insert aperture axis 188, through the inner surface 196, and then through the outer surface 194. As shown, the inner surface 196 may define the insert aperture 184.

The outer surface 194 may include a plurality of side walls 200. According to one aspect of the disclosure, the outer surface 194 includes three side walls 200 arranged such that the outer perimeter 192 of the insert body 82 is a triangular shape, for example an equilateral triangular shape.

The insert body 182 includes a plurality of cutting edges that are each configured to remove material from a work piece during a power skiving process as will be described in greater detail below. According to one aspect of the disclosure, the plurality of cutting edges includes a first cutting edge 202, and a second cutting edge 204 opposite the first cutting edge 202 with respect to the seventh direction. In accordance with one aspect of the disclosure, the insert body 182 further includes a flank face 206 at least partially, for example entirely, defined by an intersection of a first of the plurality of side walls 200a and a second of the plurality of side walls 200b.

According to one aspect of the disclosure, at least a portion of the flank face 206 extends along a straight line 208 that intersects both the first surface 186 and the second surface 190, and is parallel to the insert aperture axis 188. An entirety of the flank face 206 may be collinear with the straight line 208. An entirety of the flank face 206 may extend along the straight line 208 such that an entirety of the flank face 206 is perpendicular to the both the first surface 186 and the second surface 190. Alternatively, the flank face 206 may include a portion that is tapered toward the insert aperture axis 188, for example as represented by either of the dashed lines 206′ and 206″.

The insert body 182 may be configured such that the insert body 182 is devoid of a portion, for example a portion of the flank face 206, that crosses the straight line 208. The insert body 182 may be configured such that a radial ray 209 extends radially from the insert aperture axis 188 and intersects the straight line 208 at a first position, and the insert body 182 is devoid of a portion, for example a portion of the flank face 206, that intersects the radial ray 209 at a second position that is farther, radially, from the insert aperture axis 188 than the first position is, radially, from the insert aperture axis 188.

The insert body 182 may be configured such that the insert body 182 is devoid of a portion, for example a portion of the flank face 206, that crosses the straight line 208. The insert body 182 may be configured such that a radial ray 209 extends radially from the insert aperture axis 188 and intersects the straight line 208 at a first position, and the insert body 182 is devoid of a portion, for example a portion of the flank face 206, that intersects the radial ray 209 at a second position that is farther, radially, from the insert aperture axis 188 than the first position is, radially, from the insert aperture axis 188.

The insert body 182 may include a first nose edge 210 defined by an intersection of the flank face 206 and the first surface 186, a first flank edge 212 defined by an intersection of the first of the plurality of side walls 200a and the first surface 186, a second flank edge 214 defined by an intersection of the second of the plurality of side walls 200b and the first surface 186, or any combination thereof. The insert body 182 may further include a second nose edge 216 defined by an intersection of the flank face 206 and the second surface 190, a third flank edge 218 defined by an intersection of the first of the plurality of side walls 200a and the second surface 190, a fourth flank edge 220 defined by an intersection of the second of the plurality of side walls 200b and the second surface 190, or any combination thereof

According to one aspect of the disclosure, the first cutting edge 202 is defined by the first nose edge 210, a portion of the first flank edge 212, a portion of the second flank edge 214, or any combination thereof. The second cutting edge 204 may be defined by the second nose edge 216, a portion of the third flank edge 218, a portion of the fourth flank edge 220, or any combination thereof. For example the first cutting edge 202 may be defined by the first nose edge 210, a portion of the first flank edge 212 proximate the first nose edge 210, and a portion of the second flank edge 214 proximate the first nose edge 210, and the second cutting edge 204 may be defined by the second nose edge 216, a portion of the third flank edge 218 proximate the second nose edge 216, and a portion of the fourth flank edge 220 proximate the second nose edge 216.

The plurality of cutting edges may further include a third cutting edge 222 and a fourth cutting edge 224 opposite the third cutting edge 222 with respect to the seventh direction. The flank face 206 may be a first flank face 206 and the insert body 182 may include a second flank face 226 at least partially, for example entirely, defined by an intersection of a third of the plurality of side walls 100c and the first of the plurality of side walls 100a.

According to one aspect of the disclosure, at least a portion of the second flank face 226 extends along a second straight line 228 that intersects both the first surface 186 and the second surface 190, and is parallel to the insert aperture axis 188. An entirety of the second flank face 226 may be collinear with the second straight line 228. An entirety of the second flank face 226 may extend along the second straight line 228 such that an entirety of the second flank face 226 is perpendicular to the both the first surface 186 and the second surface 190. Alternatively, the second flank face 226 may include a portion that is tapered toward the insert aperture axis 188, for example as represented by either of the dashed lines 226′ and 226″. The insert body 182 may be configured such that the insert body 182 is devoid of a portion, for example a portion of the second flank face 226, that crosses the second straight line 228.

The insert body 182 may include a third nose edge 230 defined by an intersection of the second flank face 226 and the first surface 186, a fifth flank edge 232 defined by an intersection of the third of the plurality of side walls 200c and the first surface 186, a fourth nose edge 236 defined by an intersection of the second flank face 226 and the second surface 190, a sixth flank edge 238 defined by an intersection of the third of the plurality of side walls 200c and the second surface 190, or any combination thereof

According to one aspect of the disclosure, the third cutting edge 222 is defined by the third nose edge 230, a portion of the fifth flank edge 232, a portion of the first flank edge 212, or any combination thereof. The fourth cutting edge 224 may be defined by the fourth nose edge 236, a portion of the sixth flank edge 238, a portion of the third flank edge 218, or any combination thereof. For example the third cutting edge 222 may be defined by the third nose edge 230, a portion of the fifth flank edge 232 proximate the third nose edge 230, and a portion of the first flank edge 212 proximate the third nose edge 230, and the fourth cutting edge 224 may be defined by the fourth nose edge 236, a portion of the sixth flank edge 238 proximate the fourth nose edge 236, and a portion of the third flank edge 218 proximate the fourth nose edge 236.

The plurality of cutting edges may further include a fifth cutting edge 242 and a sixth cutting edge 244 opposite the fifth cutting edge 242 with respect to the seventh direction. The insert body 182 may include a third flank face 246 at least partially, for example entirely, defined by an intersection of the third of the plurality of side walls 200c and the second of the plurality of side walls 200b.

According to one aspect of the disclosure, at least a portion of the third flank face 246 extends along a third straight line 248 that intersects both the first surface 186 and the second surface 190, and is parallel to the insert aperture axis 188. An entirety of the third flank face 246 may be collinear with the third straight line 248. An entirety of the third flank face 246 may extend along the third straight line 248 such that an entirety of the third flank face 246 is perpendicular to the both the first surface 186 and the second surface 190. Alternatively, the third flank face 246 may include a portion that is tapered toward the insert aperture axis 188, for example as represented by either of the dashed lines 246′ and 246″. The insert body 182 may be configured such that the insert body 182 is devoid of a portion, for example a portion of the third flank face 246, that crosses the third straight line 248.

The insert body 182 may further include a fifth nose edge 250 defined by an intersection of the third flank face 246 and the first surface 186, and a sixth nose edge 256 defined by an intersection of the third flank face 246 and the second surface 190.

According to one aspect of the disclosure, the fifth cutting edge 242 is defined by the fifth nose edge 250, a portion of the fifth flank edge 232, a portion of the second flank edge 214, or any combination thereof The sixth cutting edge 244 may be defined by the sixth nose edge 256, a portion of the fourth flank edge 220, a portion of the sixth flank edge 238, or any combination thereof For example the fifth cutting edge 242 may be defined by the fifth nose edge 250, a portion of the second flank edge 214 proximate the fifth nose edge 250, and a portion of the fifth flank edge 232 proximate the fifth nose edge 250, and the sixth cutting edge 254 may be defined by the sixth nose edge 256, a portion of the fourth flank edge 220 proximate the sixth nose edge 256, and a portion of the sixth flank edge 238 proximate the sixth nose edge 256.

The first cutting edge 202, the second cutting edge 204, the third cutting edge 222, the fourth cutting edge 224, the fifth cutting edge 242, the sixth cutting edge 244, or any combination thereof may define an angle ω measured between the respective flank edges that define the respective cutting edge. For example, the first cutting edge 202 may define the angle ω between the first flank edge 212 and the second flank edge 214, the second cutting edge 204 may define the angle ω between the third flank edge 218 and the fourth flank edge 220, etc. According to one aspect of the disclosure the angle ω is less than 90°. According to one aspect of the disclosure the angle ε is about 60°. According to one aspect of the disclosure the angle ω is less than 60°. According to one aspect of the disclosure the angle ω of defined by each of the first cutting edge 202, the second cutting edge 204, the third cutting edge 222, the fourth cutting edge 224, the fifth cutting edge 242, and the sixth cutting edge 244 is equal. Alternatively, the angle ω of defined by at least two of the first cutting edge 202, the second cutting edge 204, the third cutting edge 222, the fourth cutting edge 224, the fifth cutting edge 242, and the sixth cutting edge 244 is different.

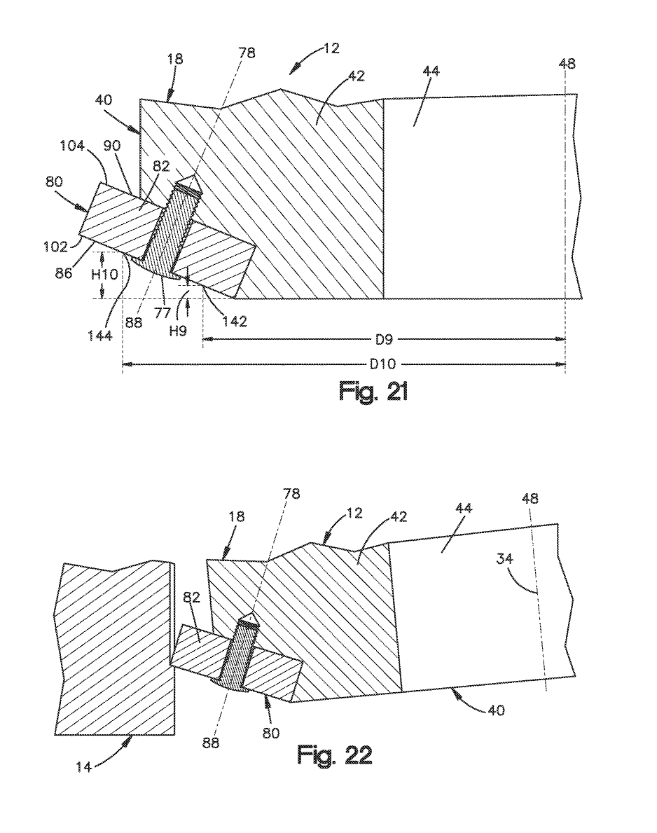

Referring to FIGS. 6, 9-14, and 21 to 22, the power skiving assembly 12 includes the insert 80 configured to be mounted to the housing 40 such that the second surface 90 that defines the second cutting edge 104 faces the housing 40, and the first surface 86 that defines the first cutting edge 102 faces away from the housing 40. According to one aspect of the disclosure, the power skiving assembly 12 includes the insert body 82 mounted to the pocket 60 of the housing 40 such that the second surface 90 that defines the second cutting edge 104 faces the base surface 62, the first surface 86 that defines the first cutting edge 102 faces away from the base surface 62, and the insert aperture axis 88 is aligned with the central fastener aperture axis 78. The power skiving assembly 12 may further include the fastener 77 configured to be inserted through the insert aperture 84 and into the fastener aperture 76 to mount the insert body 82 to the housing body 42.

According to one aspect of the disclosure, the insert 80 is configured to be mounted to the housing body 42 such that a first point 142 of the first surface 86 is spaced from the housing aperture axis 48 by a ninth distance D9 measured along a straight line that is perpendicular to the housing aperture axis 48, and the first point 142 is spaced from the plane 64 by a ninth height H9 that is measured along a straight line that is parallel to the housing aperture axis 48. The insert 80 is further configured to be mounted to the housing body 42 such that a second point 144 of the first surface 86 that is spaced from the first point 142 is spaced from the housing aperture axis 48 by a tenth distance D10 measured along a straight line that is perpendicular to the housing aperture axis 48, and the second point 144 is spaced from the plane 64 by a tenth height H10 that is measured along a straight line that is parallel to the housing aperture axis 48. As shown in the illustrated embodiment, the insert 80 is configured to be mounted to the housing body 42 such that the tenth distance D10 is greater than the ninth distance D9 and the tenth height H10 is greater than the ninth height H9.

According to one aspect of the disclosure, the power skiving assembly 12 can include the housing body 42, the housing body 342, one or more of the insert body 82, one or more of the insert body 182, or any combination thereof. According to another aspect of the disclosure, a kit is provided including the housing body 42, the housing body 342, one or more of the insert body 82, one or more of the insert body 182, or any combination thereof.

### INDUSTRIAL APPLICABILITY

Referring to FIGS. 1 to 4 and 22, the machine 10, for example the power skiving assembly 12 may be configured for use during a power skiving process. The power skiving process results in the removal of material from a work piece 14. In accordance with one aspect of the disclosure, the removal of material from the work piece 14 forms groove, for example gear teeth, in the work piece 14.

The work piece 14 is coupled to the power skiving assembly 12, for example to the clamp 20 such that the work piece 14 is restricted, for example prevented, from moving relative to the clamp 20 in at least one degree of freedom. As shown, the coupled work piece 14 and clamp 20 are rotatable about the first assembly axis of rotation 22 in the first rotational direction R1.

The tool 18 of the power skiving assembly 12, is coupled to the movable arm 16, and the coupled movable arm 16 and tool 18 are positioned offset from, for example above, the work piece 14 with respect to the first direction as shown in FIG. 1. The coupled movable arm 16 and tool 18 is rotatable about the second assembly axis of rotation 34 in the third rotational direction R3.

During a first pass of the power skiving process the coupled work piece 14 and clamp 20 are rotated about the first assembly axis of rotation 22 in the first rotational direction R1, and the coupled movable arm 16 and tool 18 is rotated about the second assembly axis of rotation 34 in the third rotational direction R3, simultaneously. During the simultaneous rotation, the coupled movable arm 16 and tool 18 is translated along the first direction, toward the work piece 14 until a portion of the tool 18, for example one or more of the plurality of inserts 80 contacts the work piece 14, referred to hereinafter as the contact phase of the first pass of the power skiving process.

During the contact phase, as shown in FIGS. 2 and 22, one of the plurality of inserts 80, hereinafter the insert 80, rotates about the second assembly axis of rotation 34 in the third rotational direction R3 until the insert 80 contacts the work piece 14. As the insert 80 contacts the work piece 14 the insert 80 translates with respect to the work piece 14 along the first direction. After travelling through a portion of a rotation about the second assembly axis of rotation 34 in the third rotational direction R3 during which the insert 80 is in contact with the work piece 14, the insert 80 disengages from contact with the work piece 14. The insert 80 continues rotating about the second assembly axis of rotation 34 in the third rotational direction R3 until the insert 80 once again contacts the work piece 14. These steps of the process repeat throughout the contact phase, for example for each of the plurality of inserts 80 coupled to the housing 40.

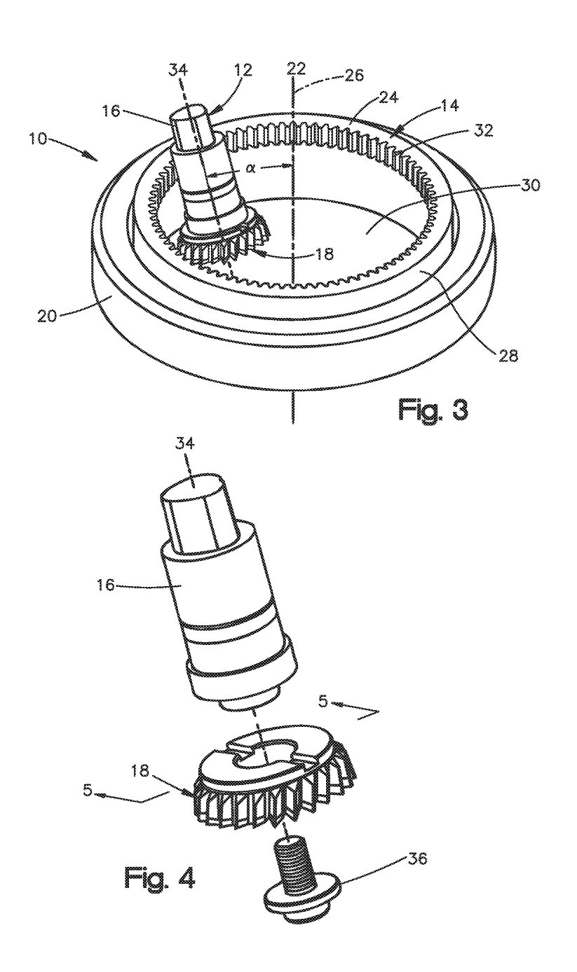

The contact phase, and the first pass, concludes when the coupled movable arm 16 and tool 18 has translated along the first direction such that the tool 18 is offset from, for example below, the work piece 14 with respect to the first direction as shown in FIG. 3.

If the work piece 14 still has material that is desired to be removed, for example if the profile of the gear teeth formed in the work piece 14 does not match the desired profile for gear teeth of the work piece 14, the power skiving process can include additional passes, each of which removes an amount of material from the work piece 14 until there is no more material that is desired to be removed from the work piece 14.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. An insert configured for use in a power skiving process, the insert comprising:
a body including a first surface, a second surface opposite the first surface with respect to a first direction, an outer surface that extends from the first surface to the second surface, and an inner surface opposite the outer surface with respect to a second direction that is perpendicular to the first direction, the body further including a first cutting edge, a second cutting edge opposite the first cutting edge with respect to the first direction, and an aperture defined by the inner surface such that the aperture extends from the first surface to the second surface.

2. The insert of claim 1, wherein the aperture extends from the first surface to the second surface along a central aperture axis that is parallel to the first direction, the outer surface includes a plurality of side walls, the body includes a flank face defined by an intersection of a first of the plurality of side walls and a second of the plurality of side walls, and an entirety of the flank face extends along a line: 1) that intersects both the first surface and the second surface and 2) is parallel to the central aperture axis.

3. The insert of claim 2, wherein the body includes a first nose edge defined by an intersection of the flank face and the first surface, a first flank edge defined by an intersection of the first of the plurality of side walls and the first surface, a second flank edge defined by an intersection of the second of the plurality of side walls and the first surface, a second nose edge defined by an intersection of the flank face and the second surface, a third flank edge defined by an intersection of the first of the plurality of side walls and the second surface, a fourth flank edge defined by an intersection of the second of the plurality of side walls and the second surface, the first cutting edge is defined by: 1) the first nose edge, 2) a portion of the first flank edge, and 3) a portion of the second flank edge, and the second cutting edge is defined by: 1) the second nose edge, 2) a portion of the third flank edge, and 3) a portion of the fourth flank edge.

4. The insert of claim 1, wherein the body includes a third cutting edge spaced from the first cutting edge along a first plane that is normal to the first direction, and a fourth cutting edge that is: 1) spaced from the second cutting edge along a second plane that is normal to the first direction and 2) opposite the third cutting edge with respect to the first direction.

5. The insert of claim 4, wherein the body includes a fifth cutting edge spaced from both the first cutting edge and the third cutting edge along the first plane, and a sixth cutting edge that is: 1) spaced from both the second cutting edge and the fourth cutting edge along the second plane and 2) opposite the fifth cutting edge with respect to the first direction.

6. The insert of claim 1, wherein the aperture extends from the first surface to the second surface along a central aperture axis that is parallel to the first direction, the outer surface includes a plurality of side walls, the body includes a flank face defined by an intersection of a first of the plurality of side walls and a second of the plurality of side walls, an intersection of the flank face and the first surface partially defines the first cutting edge, an intersection of the flank face and the second surface partially defines the second cutting edge, the intersection of the flank face and the first surface spaced from the intersection of the flank face and the second surface such that a straight line that intersects both the intersection of the flank face and the first surface and the intersection of the flank face and the second surface is parallel to the central aperture axis.

7. The insert of claim 6, wherein the body is devoid of a portion of the flank face that crosses the straight line.

8. The insert of claim 7, wherein an entirety of the flank face is collinear with the straight line.

9. A housing configured for use in a power skiving process, the housing comprising:
a body including a first surface, a second surface spaced from the first surface with respect to a first direction, an inner surface that extends along the first direction, an outer surface opposite the inner surface with respect to a second direction that is perpendicular to the first direction, an aperture defined by the inner surface such that the aperture extends from the first surface to the second surface along a central aperture axis that is parallel to the first direction, and a pocket that extends into the first surface along the first direction and terminates at a base surface of the body, the base surface including a first point and a second point that is spaced from the first point, the body further including a plane that is normal to the central aperture axis and intersecting the first surface,
wherein the first point is spaced from the central aperture axis by a first distance measured along a straight line that is perpendicular to the first direction, the first point is spaced from the plane by a first height measured along a straight line that is parallel to the first direction, the second point is spaced from the central aperture axis by a second distance measured along a straight line that is perpendicular to the first direction, the second point is spaced from the plane by a second height measured along a straight line that is parallel to the first direction, the second distance is greater than the first distance, and the second height is greater than the first height.

10. The housing of claim 9, wherein the pocket extends into the outer surface along the second direction.

11. The housing of claim 10, wherein the pocket extends into the outer surface along the second direction and terminates at an intermediate side surface of the body.

12. The housing of claim 11, wherein the intermediate side surface is perpendicular to the base surface.

13. The housing of claim 12, wherein the intermediate side surface includes a third point and a fourth point spaced from the third point, wherein the third point is spaced from the central aperture axis by a third distance measured along a straight line that is perpendicular to the first direction, the third point is spaced from the plane by a third height measured along a straight line that is parallel to the first direction, the fourth point is spaced from the central aperture axis by a fourth distance measured along a straight line that is perpendicular to the first direction, the fourth point is spaced from the plane by a fourth height measured along a straight line that is parallel to the first direction, the third distance is greater than the fourth distance, and the fourth height is greater than the third height.

14. The housing of claim 9, wherein the body includes a plurality of pockets, and the pocket is one of the plurality of pockets.

15. A power skiving assembly comprising:
a housing body including a first surface, a second surface spaced from the first surface, a pocket that extends into the first and terminates at a base surface of the housing body, and a first aperture that extends into the base surface along a central first aperture axis, the central first aperture axis being parallel to a first direction; and
an insert body including a first surface, a second surface opposite the first surface of the insert body, a second aperture that extends through both the first surface of the insert body and the second surface of the insert body along a central second aperture axis, a first cutting edge defined by the first surface of the insert body, and a second cutting edge defined by the second surface of the insert body,
wherein the insert body is configured to be mounted to the housing body such that: 1) the first surface of the insert body faces the base surface, 2) the second surface of the insert body faces away from the base surface, and 3) the central second aperture axis is aligned with the central first aperture axis.

16. The assembly of claim 15, further comprising a fastener configured to be inserted through the second aperture and into the first aperture to mount the insert body to the housing body.

17. The assembly of claim 16, wherein:
the housing body includes an outer surface, an inner surface opposite the outer surface, and a third aperture defined by the inner surface such that the third aperture extends from the first surface of the housing body to the second surface of the housing body along a central third aperture axis, the housing body defines a plane that is normal to the central third aperture axis and that intersects the first surface of the housing body, and
the first surface of the insert body includes a first point and a second point spaced from the first point, the insert body configured to be mounted to the housing body such that the first point is spaced from the central third aperture axis by a first distance measured along a straight line that is perpendicular to the central third aperture axis, the first point is spaced from the plane by a second distance measured along a straight line that is parallel to the central third aperture axis, the second point is spaced from the central third aperture axis by a third distance measured along a straight line that is perpendicular to the central third aperture axis, the second point is spaced from the plane by a fourth distance measured along a straight line that is parallel to the central third aperture axis, the third distance is greater than the first distance, and the fourth distance is greater than the second distance.

18. The assembly of claim 15, wherein the insert body is coupled to the housing body, the insert body includes a third cutting edge spaced from the first cutting edge along a first plane that is normal to the first direction, and the insert body includes a fourth cutting edge that is: 1) spaced from the second cutting edge along a second plane that is normal to the first direction and 2) opposite the third cutting edge with respect to the first direction.

19. The assembly of claim 18, wherein the insert body includes a fifth cutting edge spaced from both the first cutting edge and the third cutting edge along the first plane, and a sixth cutting edge that is: 1) spaced from both the second cutting edge and the fourth cutting edge along the second plane and 2) opposite the fifth cutting edge with respect to the first direction.

20. The assembly of claim 15, further comprising a plurality of insert bodies, wherein the insert body is one of the plurality of insert bodies, the housing body includes a plurality of pockets that each extend into the first surface and terminate at a respective one of a plurality of base surfaces of the housing body, and each of the plurality of pockets is configured to receive one of the plurality of insert bodies.
